(19) United States
(12) Patent Application Publication
(10) Pub. No.: US 2022/0083966 A1
(43) Pub. Date: Mar. 17, 2022

(54) INFORMATION PROCESSING APPARATUS, INFORMATION PROCESSING SYSTEM, NON-TRANSITORY COMPUTER READABLE MEDIUM, AND VEHICLE

(71) Applicant: TOYOTA JIDOSHA KABUSHIKI KAISHA, Toyota-shi Aichi-ken (JP)

(72) Inventors: Tae Sugimura, Miyoshi-shi Aichi-ken (JP); Kenta Miyahara, Toyota-shi Aichi-ken (JP); Shin Sakurada, Toyota-shi Aichi-ken (JP); Michael C. Edwards, McKinney, TX (US)

(73) Assignee: TOYOTA JIDOSHA KABUSHIKI KAISHA, Toyota-shi Aichi-ken (JP)

(21) Appl. No.: 17/467,999

(22) Filed: Sep. 7, 2021

(30) Foreign Application Priority Data
Sep. 11, 2020 (JP) 2020-153311

(51) Int. Cl. G06Q 10/08; G01C 21/34; G06Q 50/12

(52) U.S. Cl. CPC G06Q 10/0833; G06Q 50/12; G01C 21/3492

(57) ABSTRACT

An information processing apparatus includes a controller. The controller is configured to acquire route information on a route along which a vehicle is to travel and determine, based on the acquired route information, a delivery site at which a user on board the vehicle is to receive a delivery item to be delivered to the user.

### CROSS-REFERENCE TO RELATED APPLICATION

This application claims priority to Japanese Patent Application No. 2020-153311, filed on Sep. 11, 2020, the entire contents of which are incorporated herein by reference.

### TECHNICAL FIELD

The present disclosure relates to an information processing apparatus, an information processing system, a program, and a vehicle.

### BACKGROUND

Technology for delivering a package to a predetermined destination, such as a home, within a specified time is known. For example, patent literature (PTL) 1 discloses a delivery plan formulation method for formulating a delivery plan such that, when there is a package that cannot be delivered within a specified time among packages to be loaded on a delivery vehicle, a portion of the packages is excluded to eliminate the package that cannot be delivered within the specified time.

### CITATION LIST

### Patent Literature

PTL 1: JP 2004-323229 A

### SUMMARY

However, known technology has room for improvement to enable a user, who is on board a vehicle that is traveling, to receive a delivery item at a suitable delivery site.

It would be helpful to provide technology enabling a user, who is on board a vehicle that is traveling, to receive a delivery item at a suitable delivery site.

An information processing apparatus according to an embodiment of the present disclosure includes a controller configured to:

acquire route information on a route along which a vehicle is to travel; and

determine, based on the acquired route information, a delivery site at which a user on board the vehicle is to receive a delivery item to be delivered to the user.

A program according to an embodiment of the present disclosure is configured to cause an information processing apparatus to perform operations including:

acquiring route information on a route along which a vehicle is to travel; and

determining, based on the acquired route information, a delivery site at which a user on board the vehicle is to receive a delivery item to be delivered to the user.

A vehicle according to an embodiment of the present disclosure includes a controller configured to:

acquire route information on a route along which the vehicle is to travel; and

determine, based on the acquired route information, a delivery site at which a user on board the vehicle is to receive a delivery item to be delivered to the user.

According to the information processing apparatus, the information processing system, the program, and the vehicle of embodiments of the present disclosure, a user, who is on board a vehicle that is traveling, can receive a delivery item at a suitable delivery site.

### BRIEF DESCRIPTION OF THE DRAWINGS

In the accompanying drawings:

FIG. 1 is a configuration diagram illustrating a configuration of an information processing system that includes an information processing apparatus according to an embodiment of the present disclosure;

FIG. 2 is a functional block diagram illustrating schematic configurations of the information processing apparatus, a vehicle, and a terminal apparatus of FIG. 1;

FIG. 3 is a sequence diagram for illustrating an example of an information processing method executed by the information processing system of FIG. 1;

FIG. 4 is a flowchart illustrating a first example of an information processing method executed by the information processing apparatus of FIG. 1;

FIG. 5 is a flowchart illustrating a second example of an information processing method executed by the information processing apparatus of FIG. 1;

FIG. 6 is a diagram for illustrating a first example of processing by a controller of the information processing apparatus of FIG. 2;

FIG. 7A is a schematic diagram according to a first example illustrating how a delivery site is displayed by an output interface of a vehicle;

FIG. 7B is a schematic diagram according to a second example illustrating how a delivery site is displayed by an output interface of a vehicle;

FIG. 7C is a schematic diagram according to a third example illustrating how a delivery site is displayed by an output interface of a vehicle; and

FIG. 8 is a diagram for illustrating a second example of processing by a controller of the information processing apparatus of FIG. 2.

### DETAILED DESCRIPTION

Embodiments of the present disclosure are described below with reference to the drawings.

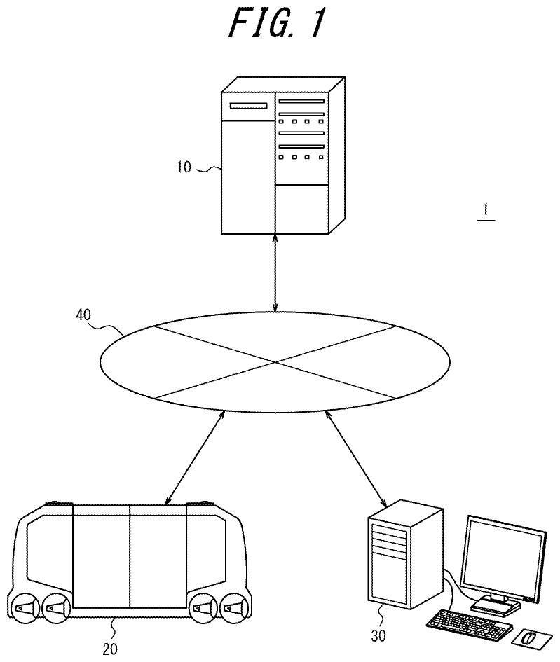

FIG. 1 is a configuration diagram illustrating a configuration of an information processing system 1 that includes an information processing apparatus 10 according to an embodiment of the present disclosure. With reference to FIG. 1, an overview of the information processing system 1 that includes the information processing apparatus 10 according to an embodiment of the present disclosure is primarily described. In addition to the information processing apparatus 10, the information processing system 1 includes a vehicle 20 and a terminal apparatus 30.

In FIG. 1, one each of the information processing apparatus 10, the vehicle 20, and the terminal apparatus 30 are illustrated for the sake of simplicity, but the number of information processing apparatuses 10, vehicles 20, and terminal apparatuses 30 included in the information processing system 1 may be two or more of each. Each of the information processing apparatus 10, the vehicle 20, and the terminal apparatus 30 is communicably connected to a network 40 including, for example, a mobile communication network and/or the Internet.

The information processing apparatus 10 is a single server apparatus or a plurality of server apparatuses that can communicate with each other. The information processing apparatus 10 is not limited to being a server apparatus and may be any general purpose electronic device, such as a personal computer (PC) or smartphone, or may be another electronic device dedicated to the information processing system 1.

The vehicle 20 is, for example, an automobile. The vehicle 20 is not limited to an automobile and may be any vehicle on which a person can board and ride to a destination. The vehicle 20 is, for example, a vehicle that performs autonomous driving. The autonomous driving may be at any level from level 1 to level 5 as defined by the Society of Automotive Engineers (SAE), for example, but is not limited to these levels and may be defined in any appropriate way. The vehicle 20 is not limited to a vehicle that performs autonomous driving and may be any vehicle driven by a driver.

The terminal apparatus 30 is a general purpose electronic device, such as a PC or smartphone, for example. The terminal apparatus 30 is, for example, an electronic device managed by a service provider that delivers delivery items to users on board the traveling vehicle 20. The terminal apparatus 30 is not limited to this example and may be a single server apparatus, or a plurality of server apparatuses that can communicate with each other, managed by the service provider. The terminal apparatus 30 may also be an electronic device dedicated to the information processing system 1. In the present disclosure, a “service provider” includes any business that provides services related to delivery, eating and drinking, retailing, or the like.

As a summary of an embodiment, the information processing apparatus 10 acquires route information on a route along which the vehicle 20 is to travel. In the present disclosure, the “route information” includes, for example, the actual route to a predetermined destination set by a user on board the vehicle 20 using a car navigation device or the like. Additionally, the route information includes, for example, the current positional information for the vehicle 20.

The information processing apparatus 10 determines, based on the acquired route information, a delivery site at which the user on board the vehicle 20 is to receive a delivery item to be delivered to the user. In the present disclosure, the “delivery item” includes, for example, a package sent from any sender to the user on board the vehicle 20. The delivery item is not limited to this case and may, for example, include a food item such as a food and/or beverage. In the present disclosure, the “food item” may, for example, include a first food item that the user on board the vehicle 20 ordered for delivery during travel of the vehicle 20 or before the vehicle 20 departed from the departure point, or may include a second food item similar to the first food item and contained in the same category as the first food item.

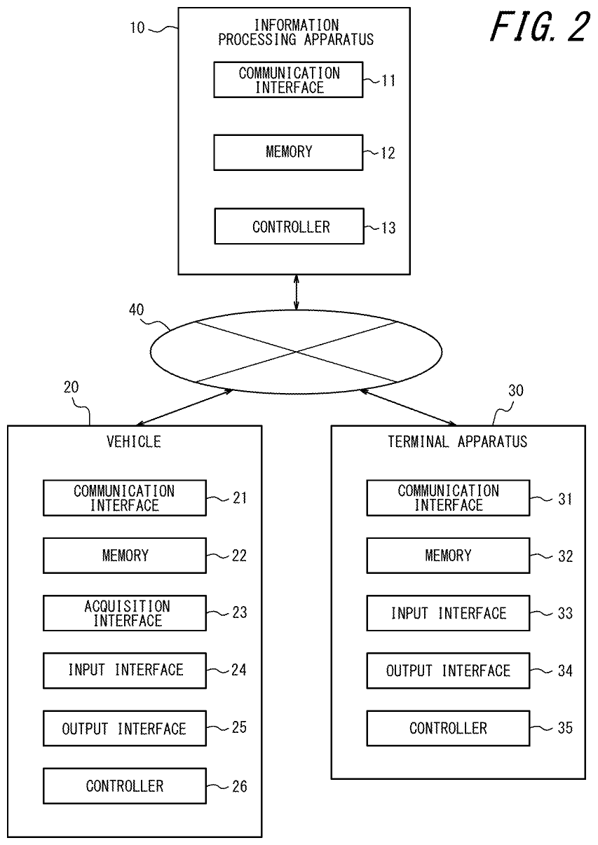

Next, with reference to FIG. 2, configurations of the information processing apparatus 10, the vehicle 20, and the terminal apparatus 30 included in the information processing system 1 are primarily described. FIG. 2 is a functional block diagram illustrating schematic configurations of the information processing apparatus 10, the vehicle 20, and the terminal apparatus 30 of FIG. 1.

As illustrated in FIG. 2, the information processing apparatus 10 includes a communication interface 11, a memory 12, and a controller 13.

The communication interface 11 includes a communication module that connects to the network 40. For example, the communication interface 11 may include a communication module compliant with mobile communication standards such as 4th Generation (4G) and 5th Generation (5G) or with Internet standards. In an embodiment, the information processing apparatus 10 is connected to the network 40 via the communication interface 11. The communication interface 11 transmits and receives various information via the network 40.

The memory 12 is, for example, a semiconductor memory, a magnetic memory, an optical memory, or the like, but is not limited to these. The memory 12 may, for example, function as a main memory, an auxiliary memory, or a cache memory. The memory 12 stores any information used for operations of the information processing apparatus 10. For example, the memory 12 may store a system program, an application program, various types of information received or transmitted by the communication interface 11, and the like. The information stored in the memory 12 may, for example, be updated with information received from the network 40 via the communication interface 11.

The controller 13 includes one or more processors. The “processor” in an embodiment is a general purpose processor or a dedicated processor that is dedicated to specific processing, but the processor is not limited to these. The controller 13 is communicably connected to each component forming the information processing apparatus 10 and controls operations of the information processing apparatus 10 overall.

Next, the configuration of the vehicle 20 included in the information processing system 1 is primarily described. As illustrated in FIG. 2, the vehicle 20 includes a communication interface 21, a memory 22, an acquisition interface 23, an input interface 24, an output interface 25, and a controller 26. The communication interface 21, the memory 22, the acquisition interface 23, the input interface 24, the output interface 25, and the controller 26 are, for example, communicably connected to each other via an in-vehicle network, such as a controller area network (CAN), or a dedicated line.

The communication interface 21 includes a communication module that connects to the network 40. For example, the communication interface 21 may include a communication module compliant with mobile communication standards such as 4G and 5G. In an embodiment, the vehicle 20 is connected to the network 40 via the communication interface 21. The communication interface 21 transmits and receives various information via the network 40.

The memory 22 is, for example, a semiconductor memory, a magnetic memory, an optical memory, or the like, but is not limited to these. The memory 22 may, for example, function as a main memory, an auxiliary memory, or a cache memory. The memory 22 stores any information used for operations of the vehicle 20. For example, the memory 22 may store a system program, an application program, various types of information received or transmitted by the communication interface 21, and the like. The information stored in the memory 22 may, for example, be updated with information received from the network 40 via the communication interface 21.

The acquisition interface 23 includes any module capable of acquiring a route to a predetermined destination set by the user on board the vehicle 20, traffic information for the route, and the like. For example, the acquisition interface 23 includes a module constituting part of a car navigation device.

The acquisition interface 23 includes one or more receivers compliant with any appropriate satellite positioning system. For example, the acquisition interface 23 may include a Global Positioning System (GPS) receiver. The acquisition interface 23 acquires the measured position of the vehicle 20 as positional information. The positional information includes, for example, an address, latitude, longitude, altitude, and the like. The acquisition interface 23 may acquire the positional information for the vehicle 20 continually, regularly, or non-regularly.

The input interface 24 includes one or more interfaces for input that receive an input operation by an occupant in the cabin of the vehicle 20 and acquire input information based on the input operation by the occupant. For example, the input interface 24 includes an interface for input that forms part of a car navigation device. For example, the input interface 24 includes a touchscreen integrally provided with a liquid crystal monitor forming part of a car navigation device. The input interface 24 receives an input operation by the occupant based on a touch operation by the occupant, for example.

The input interface 24 may include, but is not limited to, any input interface for input capable of detecting an input operation by an occupant and acquiring input information based on the input operation by the occupant. The input interface 24 may, for example, include a physical key, a capacitive key, a microphone that accepts audio input, and the like.

The output interface 25 includes, for example, one or more interfaces for output that output information to an occupant in the cabin of the vehicle 20. For example, the output interface 25 includes an interface for output that forms part of a car navigation device. For example, the output interface 25 includes a liquid crystal monitor that forms part of a car navigation device. The output interface 25 outputs information by image and/or sound, for example.

The output interface 25 may include, but is not limited to, any interface for output that stimulates the sense of sight and/or hearing of an occupant of the vehicle 20. The output interface 25 may, for example, include any other audio output interface, other than a car navigation device, that primarily stimulates the sense of hearing of the occupant of the vehicle 20. The output interface 25 may, for example, include any other image output interface, other than a car navigation device, that primarily stimulates the sense of sight of the occupant of the vehicle 20.

The controller 26 includes one or more processors. The “processor” in an embodiment is a general purpose processor or a dedicated processor that is dedicated to specific processing, but the processor is not limited to these. For example, the controller 26 may include an Electronic Control Unit (ECU). The controller 26 is communicably connected to each component forming the vehicle 20 and controls operations of the vehicle 20 overall.

Next, the configuration of the terminal apparatus 30 included in the information processing system 1 is primarily described. As illustrated in FIG. 2, the terminal apparatus 30 includes a communication interface 31, a memory 32, an input interface 33, an output interface 34, and a controller 35.

The communication interface 31 includes a communication module that connects to the network 40. For example, the communication interface 31 may include a communication module compliant with mobile communication standards such as 4G and 5G or with Internet standards. In an embodiment, the terminal apparatus 30 is connected to the network 40 via the communication interface 31. The communication interface 31 transmits and receives various information via the network 40.

The memory 32 is, for example, a semiconductor memory, a magnetic memory, an optical memory, or the like, but is not limited to these. The memory 32 may, for example, function as a main memory, an auxiliary memory, or a cache memory. The memory 32 stores any information used for operations of the terminal apparatus 30. For example, the memory 32 may store a system program, an application program, various types of information received or transmitted by the communication interface 31, and the like. The information stored in the memory 32 may, for example, be updated with information received from the network 40 via the communication interface 31.

The input interface 33 includes one or more interfaces for input to detect user input and acquire input information based on user operations. For example, the input interface 33 may include a physical key, a capacitive key, a touchscreen integrally provided with a display of the output interface 34, a microphone that accepts audio input, or the like.

The output interface 34 includes one or more interfaces for output to output information and notify the user. For example, the output interface 34 includes, but is not limited to, a display for outputting information as video, a speaker for outputting information as audio, or the like.

The controller 35 includes one or more processors. The “processor” in an embodiment is a general purpose processor or a dedicated processor that is dedicated to specific processing, but the processor is not limited to these. The controller 35 is communicably connected to each component forming the terminal apparatus 30 and controls operations of the terminal apparatus 30 overall.

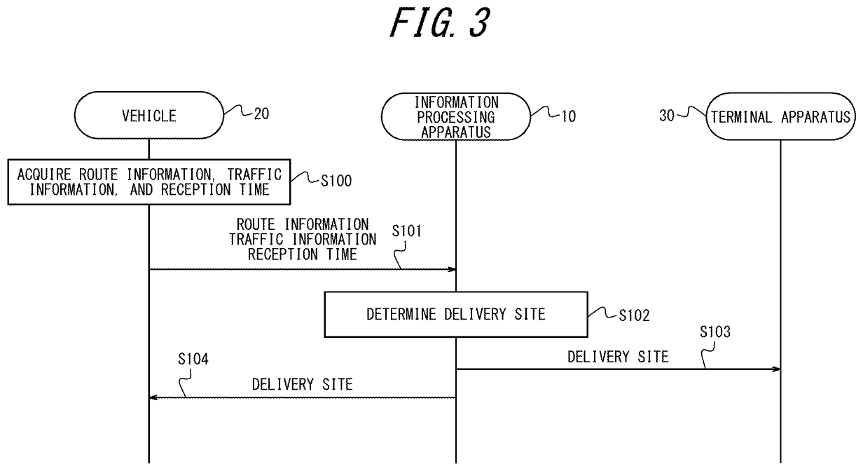

FIG. 3 is a sequence diagram for illustrating an example of an information processing method executed by the information processing system 1 of FIG. 1. With reference to FIG. 3, an example information processing method executed by the information processing system 1 of FIG. 1 is described. The sequence diagram in FIG. 3 illustrates the flow of basic processing of the information processing method executed by the information processing system 1.

In step S100, the controller 26 of the vehicle 20 acquires route information on a route along which a vehicle 20 is to travel and traffic information for the route. For example, from the acquisition interface 23, the controller 26 acquires the route information from the departure point to the destination inputted by the user, as an occupant, at the departure point using the input interface 24. For example, the controller 26 acquires the traffic information for the route from the departure point to the destination from the acquisition interface 23. In addition, the controller 26 acquires the reception time at which the user wishes to receive the delivery item. For example, the controller 26 acquires the reception time, inputted by the user using the input interface 24, from the input interface 24.

In step S101, the controller 26 of the vehicle 20 transmits the route information, the traffic information, and the reception time acquired in step S100 to the information processing apparatus 10 via the communication interface 21 and the network 40. The controller 13 of the information processing apparatus 10 acquires the route information on the route along which the vehicle 20 is to travel. The controller 13 acquires the traffic information for the route. The controller 13 acquires the reception time at which the user wishes to receive the delivery item.

In step S102, the controller 13 of the information processing apparatus 10 determines a delivery site for the user to receive the delivery item to be delivered to the user on board the vehicle 20 based on the route information acquired in step S101. At this time, the controller 13 may determine the delivery site based on the traffic information and/or the reception time acquired in step S101 in addition to the route information.

In step S103, the controller 13 of the information processing apparatus 10 transmits information on the delivery site determined in step S102 to the terminal apparatus 30 via the communication interface 11 and the network 40. The service provider carries out delivery operations so that the delivery item to be delivered to the user on board the vehicle 20 can be delivered to the user at the delivery site notified by the terminal apparatus 30.

In step S104, the controller 13 of the information processing apparatus 10 transmits the information on the delivery site determined in step S102 to the vehicle 20 via the communication interface 11 and the network 40. The vehicle 20 may autonomously drive to the corresponding delivery site based on the acquired information or may assist the driver in driving to the delivery site by indicating the route to the delivery site to the driver using, for example, the output interface 25.

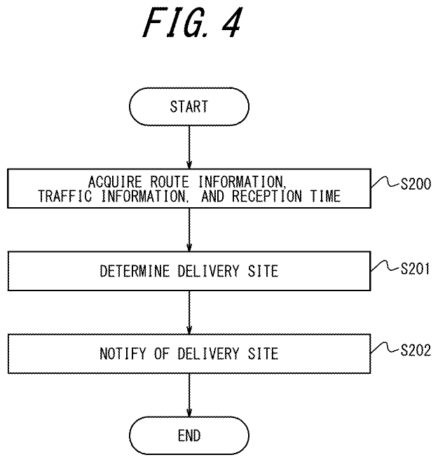

FIG. 4 is a flowchart illustrating a first example of an information processing method executed by the information processing apparatus 10 of FIG. 1. The flowchart in FIG. 4 illustrates the flow of basic processing of the information processing method executed by the information processing apparatus 10. The flowchart illustrated in FIG. 4 applies both when the delivery item is a package and when the delivery item is a food item, for example, sent from any sender to the user on board the vehicle 20.

In step S200, the controller 13 of the information processing apparatus 10 acquires route information on a route along which the vehicle 20 is to travel. The controller 13 acquires traffic information for the route. The controller 13 acquires the reception time at which the user wishes to receive the delivery item. For example, the controller 13 receives these pieces of information from the vehicle 20 via the network 40 and the communication interface 11.

In step S201, the controller 13 determines a delivery site for the user to receive the delivery item to be delivered to the user on board the vehicle 20 based on the route information acquired in step S200. At this time, the controller 13 may determine the delivery site based on the traffic information and/or the reception time acquired in step S200 in addition to the route information.

In step S202, the controller 13 provides information on the delivery site determined in step S201 to the vehicle 20 and the terminal apparatus 30. For example, the controller 13 transmits the information on the delivery site determined in step S201 to the vehicle 20 and the terminal apparatus 30 via the communication interface 11 and the network 40.

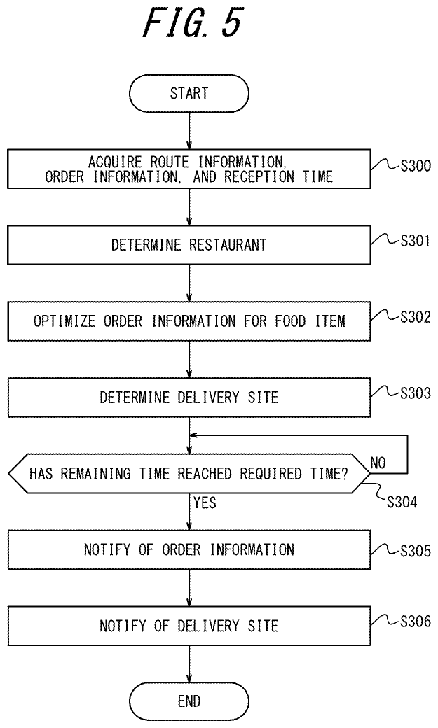

FIG. 5 is a flowchart illustrating a second example of an information processing method executed by the information processing apparatus 10 of FIG. 1. The flowchart in FIG. 5 illustrates the flow of processing for delivering a food item to the user as a delivery item.

In step S300, the controller 13 of the information processing apparatus 10 acquires route information on a route along which the vehicle 20 is to travel. The controller 13 acquires the reception time at which the user wishes to receive the food item. The controller 13 acquires order information regarding delivery of the food item to be delivered. In the present disclosure, the “order information” includes, for example, menu information, quantity, and the like relating to the food item. For example, the controller 26 of the vehicle 20 acquires the order information, inputted by the user using the input interface 24, from the input interface 24. For example, the controller 13 receives these pieces of information from the vehicle 20 via the network 40 and the communication interface 11.

In step S301, the controller 13 determines a restaurant capable of delivering a first food item ordered for delivery by the user, or a second food item similar to the first food item and included in the same category as the first food item, by the reception time acquired in step S300. At this time, the controller 13 may determine the restaurant capable of delivering the food item by the reception time while making a comprehensive judgment based on the route information and/or the order information acquired in step S300 in addition to the reception time.

In step S302, the controller 13 optimizes the order information regarding delivery of the food item based on past route information acquired in step S300.

In step S303, the controller 13 determines a delivery site for the user to receive the food item to be delivered to the user on board the vehicle 20 based on the route information acquired in step S300. At this time, the controller 13 may determine the delivery site based on the reception time acquired in step S300 in addition to the route information.

In step S304, the controller 13 judges whether the remaining time until the reception time acquired in step S300 has reached a required time. When it is judged that the remaining time has reached the required time, the controller 13 executes the process of step S305. When it is judged that the remaining time has not reached the required time, the controller 13 executes the process of step S304 again. That is, the controller 13 waits without executing the process for notification of the order information, described below, in step S305.

In the present disclosure, the “required time” includes, for example, the time required from when the restaurant determined in step S301 starts preparing the food item until delivery is complete. For example, the controller 13 may calculate the required time based on information, acquired from the terminal apparatus 30, on the average food item preparation time in the restaurant and the average travel time by a delivery vehicle from the restaurant to the delivery site determined in step S303.

When it is judged that the remaining time has reached the required time in step S304, the controller 13 then notifies, in step S305, the restaurant determined in step S301 of the order information, acquired in step S300, regarding delivery of the food item. For example, the controller 13 transmits the order information, acquired in step S300, regarding delivery of the food item to the terminal apparatus 30 via the communication interface 11 and the network 40.

In step S306, the controller 13 provides information on the delivery site determined in step S303 to the vehicle 20 and the terminal apparatus 30. For example, the controller 13 transmits the information on the delivery site determined in step S303 to the vehicle 20 and the terminal apparatus 30 via the communication interface 11 and the network 40.

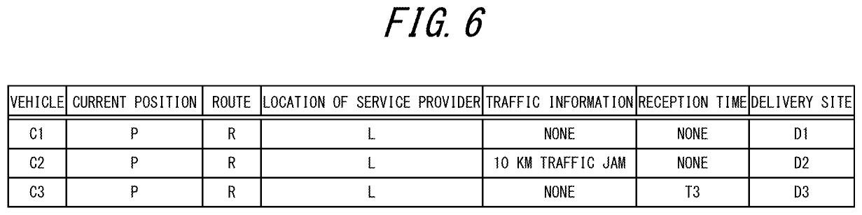

FIG. 6 is a diagram for illustrating a first example of processing by the controller 13 of the information processing apparatus 10 of FIG. 2. With reference to FIG. 6, processing executed by the controller 13 to determine the delivery site is described in greater detail. In FIG. 6, a delivery company is assumed as the service provider, and a package sent from any suitable sender to the user on board the vehicle 20 is assumed as the delivery item.

Although specific examples are provided for three vehicles C1 to C3 in FIG. 6, the number of vehicles 20 included in the information processing system 1 is not limited to three. For the sake of convenience, the same current position P and route R are assumed in FIG. 6 for the vehicles C1 to C3, but the current position and route may differ for each vehicle 20. Similarly, although the same location L is assumed for the vehicles C1 to C3 as the location of the delivery facility of the service provider, the location of the service provider may differ for each vehicle 20.

The controller 13 acquires, from the terminal apparatus 30, information indicating that a package sent to the user on board the vehicle C1 is stored in the delivery facility of the service provider at location L. The controller 13 acquires, as route information during travel of the vehicle C1, information indicating the route R and the current position P on the route R from the vehicle C1. For the vehicle C1, however, the controller 13 does not acquire the traffic information or the reception time from the vehicle C1.

At this time, the controller 13 determines, based on the acquired route information, a delivery site D1 at which the user on board the vehicle C1 is to receive the package to be delivered to the user. For example, the delivery site D1 is an intermediate point between the current position P of the vehicle C1 and the location L of the service provider and is located along the route R of the vehicle C1. The controller 13 transmits the information on the determined delivery site D1 to the vehicle C1 and the terminal apparatus 30 via the communication interface 11 and the network 40. At this time, the controller 13 may, as needed, also transmit information on the location L of the service provider to the vehicle C1 via the communication interface 11 and the network 40.

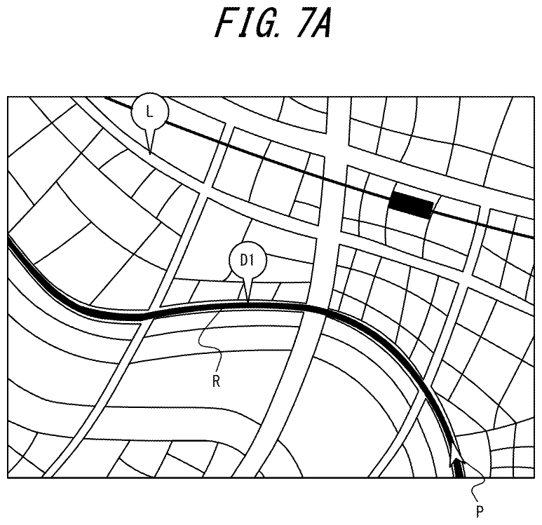

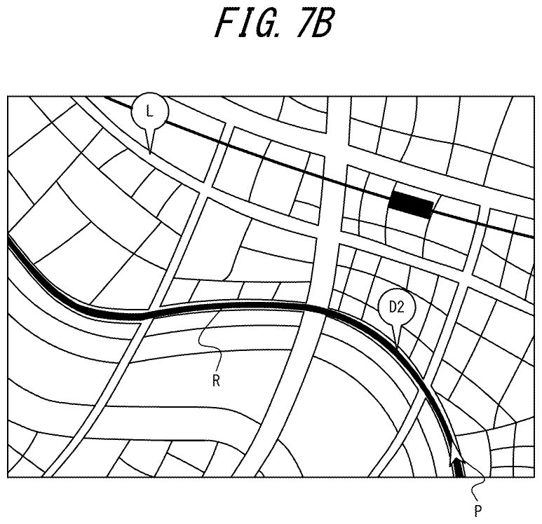

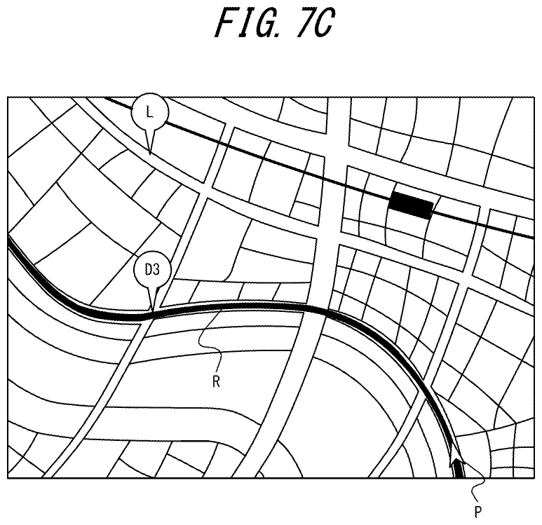

FIG. 7A is a schematic diagram according to a first example illustrating how a delivery site is displayed by the output interface 25 of the vehicle 20. For example, the controller 26 of the vehicle C1, which has acquired the information on the delivery site D1 and the location L from the information processing apparatus 10, may display the delivery site D1 and the location L on the output interface 25 along with the route R of the vehicle C1 and the current position P on the route R. The vehicle C1 travels to the delivery site D1 autonomously or by being driven by a driver. The user on board the vehicle C1 receives the necessary package from the delivery company at the delivery site D1.

Referring again to FIG. 6, the controller 13 acquires, from the terminal apparatus 30, information indicating that a package sent to the user on board the vehicle C2 is stored in the delivery facility of the service provider at location L. The controller 13 acquires, as route information during travel of the vehicle C2, information indicating the route R and the current position P on the route R from the vehicle C2. In addition, the controller 13 acquires information, from the vehicle C2, indicating a 10 km traffic jam as traffic information for the route R. For the vehicle C2, however, the controller 13 does not acquire the reception time from the vehicle C2.

At this time, the controller 13 determines, based on the acquired route information and traffic information, a delivery site D2 at which the user on board the vehicle C2 is to receive the package to be delivered to the user. For example, the controller 13 determines the delivery site D2 by judging that a traffic jam has occurred along the route R and that the vehicle C2 can only travel a short distance from the current position P on the route R while the delivery vehicle of the service provider travels. For example, the delivery site D2 is located on the route R closer to the current position P than the delivery site D1 illustrated in FIG. 7A. The controller 13 transmits the information on the determined delivery site D2 to the vehicle C2 and the terminal apparatus 30 via the communication interface 11 and the network 40. At this time, the controller 13 may, as needed, also transmit information on the location L of the service provider to the vehicle C2 via the communication interface 11 and the network 40.

FIG. 7B is a schematic diagram according to a second example illustrating how a delivery site is displayed by the output interface 25 of the vehicle 20. For example, the controller 26 of the vehicle C2, which has acquired the information on the delivery site D2 and the location L from the information processing apparatus 10, may display the delivery site D2 and the location L on the output interface 25 along with the route R of the vehicle C2 and the current position P on the route R. The vehicle C2 travels to the delivery site D2 autonomously or by being driven by a driver. The user on board the vehicle C2 receives the necessary package from the delivery company at the delivery site D2.

Referring again to FIG. 6, the controller 13 acquires, from the terminal apparatus 30, information indicating that a package sent to the user on board the vehicle C3 is stored in the delivery facility of the service provider at location L. The controller 13 acquires, as route information during travel of the vehicle C3, information indicating the route R and the current position P on the route R from the vehicle C3. In addition, the controller 13 acquires a reception time T3, from the vehicle C3, at which the user wishes to receive the package. For the vehicle C3, however, the controller 13 does not acquire the traffic information from the vehicle C3.

At this time, the controller 13 determines, based on the acquired route information and reception time T3, a delivery site D3 at which the user on board the vehicle C3 is to receive the package to be delivered to the user. For example, the controller 13 determines the delivery site D3 by estimating the distance that the vehicle C3 can travel on the route R until the reception time T3 is reached. When there is ample time until the reception time T3, for example, the controller 13 determines the delivery site D3 by judging that the vehicle C3 is capable of traveling a long distance from the current position P on the route R until the reception time T3. For example, the delivery site D3 is located on the route R closer to the location L than the delivery site D1 illustrated in FIG. 7A. The controller 13 transmits the information on the determined delivery site D3 to the vehicle C3 and the terminal apparatus 30 via the communication interface 11 and the network 40. At this time, the controller 13 may, as needed, also transmit information on the location L of the service provider to the vehicle C3 via the communication interface 11 and the network 40.

FIG. 7C is a schematic diagram according to a third example illustrating how a delivery site is displayed by the output interface 25 of the vehicle 20. For example, the controller 26 of the vehicle C3, which has acquired the information on the delivery site D3 and the location L from the information processing apparatus 10, may display the delivery site D3 and the location L on the output interface 25 along with the route R of the vehicle C3 and the current position P on the route R. The vehicle C3 travels to the delivery site D3 autonomously or by being driven by a driver. The user on board the vehicle C3 receives the necessary package from the delivery company at the delivery site D3.

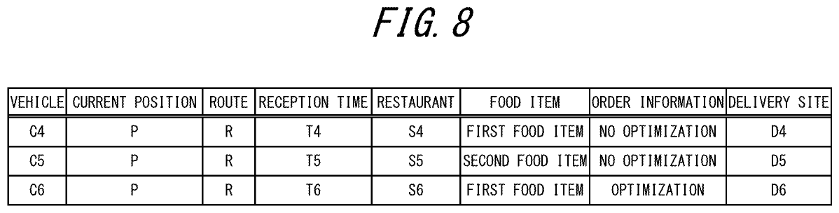

FIG. 8 is a diagram for illustrating a second example of processing by the controller 13 of the information processing apparatus 10 of FIG. 2. With reference to FIG. 8, processing executed by the controller 13 to determine a restaurant and to optimize order information regarding delivery of a food item is described in greater detail. In FIG. 8, a restaurant is assumed as the service provider, and a food item is assumed as a delivery item.

Although specific examples are provided for three vehicles C4 to C6 in FIG. 8, the number of vehicles 20 included in the information processing system 1 is not limited to three. For the sake of convenience, the same current position P and route R are assumed in FIG. 8 for the vehicles C4 to C6, but the current position and route may differ for each vehicle 20.

The controller 13 acquires order information regarding delivery of a first food item from the vehicle C4. The controller 13 acquires, as route information during travel of the vehicle C4, information indicating the route R and the current position P on the route R from the vehicle C4. In addition, the controller 13 acquires a reception time T4, from the vehicle C4, at which the user wishes to receive the first food item.

At this time, based on the acquired reception time T4, the controller 13 determines a restaurant S4 capable of delivering the first food item ordered for delivery by the user by the reception time T4. For example, based also on the acquired current position P and route R of the vehicle C4, the controller 13 may list a plurality of restaurants located at positions where the first food item can be delivered by the reception time T4 as candidates and determine a particular restaurant S4 from among the candidates by any appropriate method. For example, based also on the acquired order information regarding delivery of the first food item, the controller 13 may list a plurality of restaurants capable of preparing the necessary amount of the menu item in accordance with the order information and delivering the first food item by the reception time T4 as candidates. The controller 13 may then determine a particular restaurant S4 from among the candidates by any appropriate method.

When it is judged that the order information regarding delivery of the first food item is compatible with past route information of the vehicle C4, for example, the controller 13 does not execute the process to optimize the order information based on the route information. For example, when it is judged that the user on board the vehicle C4 has not had anything to eat or drink for a long time based on the past route information of the vehicle C4, and that the content and amount of the first food item included in the order information are optimal for the user, the controller 13 does not execute the process to optimize the order information based on the route information.

The controller 13 may determine the delivery site D4 in the same manner as the process to determine the delivery site D3 for the vehicle C3 described with reference to FIG. 6, for example.

The controller 13 acquires order information regarding delivery of a first food item from the vehicle C5. The controller 13 acquires, as route information during travel of the vehicle C5, information indicating the route R and the current position P on the route R from the vehicle C5. In addition, the controller 13 acquires a reception time T5, from the vehicle C5, at which the user wishes to receive the first food item.

For example, based on the acquired reception time T5, the controller 13 judges that there are no candidate restaurants capable of delivering the first food item ordered for delivery by the user by the reception time T5. At this time, the controller 13 may determine a restaurant S5 that is capable of delivering a second food item, which is included in the same category as the first food item and is similar to the first food item, by the reception time T5. For example, based also on the acquired current position P and route R of the vehicle C5, the controller 13 may list a plurality of restaurants located at positions where the second food item can be delivered by the reception time T5 as candidates and determine a particular restaurant S5 from among the candidates by any appropriate method. For example, based also on the acquired order information regarding delivery of the first food item, the controller 13 may list a plurality of restaurants capable of preparing the necessary amount of the menu item that corresponds to the order information and delivering the second food item by the reception time T5 as candidates. The controller 13 may then determine a particular restaurant S5 from among the candidates by any appropriate method.

At this time, the controller 13 may provide the vehicle C5 with information on the content of the second food item and the restaurant S5 that were determined and cause the output interface 25 of the vehicle C5 to display the information. The controller 13 may notify the restaurant S5 of the order information after acquiring approval information, via the input interface 24 of the vehicle C5, from the user with regard to this information displayed on the output interface 25.

When it is judged that the order information regarding delivery of the first food item is compatible with past route information of the vehicle C5, for example, the controller 13 does not execute the process to optimize the order information based on the route information. For example, when it is judged that the user on board the vehicle C5 has not had anything to eat or drink for a long time based on the past route information of the vehicle C5, and that the content and amount of the second food item corresponding to the order information are optimal for the user, the controller 13 does not execute the process to optimize the order information based on the route information.

The controller 13 may determine the delivery site D5 in the same manner as the process to determine the delivery site D3 for the vehicle C3 described with reference to FIG. 6, for example.

The controller 13 acquires order information regarding delivery of a first food item from the vehicle C6. The controller 13 acquires, as route information during travel of the vehicle C6, information indicating the route R and the current position P on the route R from the vehicle C6. In addition, the controller 13 acquires a reception time T6, from the vehicle C6, at which the user wishes to receive the first food item.

At this time, based on the acquired reception time T6, the controller 13 determines a restaurant S6 capable of delivering the first food item ordered for delivery by the user by the reception time T6, as in the case of the vehicle C4.

When it is judged that the order information regarding delivery of the first food item is not compatible with past route information of the vehicle C6, for example, the controller 13 executes the process to optimize the order information based on the route information. For example, when it is judged that the user on board the vehicle C6 has not had anything to eat or drink for a long time based on the past route information of the vehicle C6, and that the content and amount of the first food item included in the order information are not optimal for the user, the controller 13 executes the process to optimize the order information based on the route information. For example, the controller 13 optimizes the order information so as to increase the amount of the first food item when it is judged that the amount of the first food item included in the order information is small for the user.

At this time, the controller 13 may provide the optimized order information to the vehicle C6 and cause the output interface 25 of the vehicle C6 to display the optimized order information. The controller 13 may notify the restaurant S6 of the optimized order information after acquiring approval information, via the input interface 24 of the vehicle C6, from the user with regard to the order information displayed on the output interface 25.

The controller 13 may determine the delivery site D6 in the same manner as the process to determine the delivery site D3 for the vehicle C3 described with reference to FIG. 6, for example.

According to the above embodiment, the user on board the vehicle 20 that is traveling can receive a delivery item at a suitable delivery site. For example, the information processing apparatus 10 determines, based on the acquired route information of the vehicle 20, a delivery site at which the user on board the vehicle 20 is to receive a delivery item to be delivered to the user. This enables the user to receive the necessary delivery item even along the travel route of the vehicle 20 on which the user is riding, without being limited to a fixed location such as a house, for example. Accordingly, the convenience for the user who uses the information processing system 1 improves.

By determining the delivery site based on the acquired traffic information, the information processing apparatus 10 can flexibly determine the suitable delivery site in accordance with the state of traffic on the route when the vehicle 20 travels. For example, if a traffic jam occurs along the route, the information processing apparatus 10 can determine the delivery site to be a location along the route closer to the current position of the vehicle 20. Conversely, if a traffic jam has not occurred along the route, the information processing apparatus 10 can determine the delivery site to be a location along the route closer to the location of the service provider.

By determining the delivery site based on the acquired reception time, the information processing apparatus 10 can determine a suitable delivery site in conjunction with the time at which the user on board the vehicle 20 wishes to receive the delivery item. For example, if there is ample time until the reception time, information processing apparatus 10 can determine the delivery site to be a location along the route closer to the location of the service provider. Conversely, if there is not ample time until the reception time, the information processing apparatus 10 can determine the delivery site to be a location that is an intermediate point between the current position of the vehicle 20 and the location of the service provider and is along the route of the vehicle 20. The user can reliably receive the delivery item at the desired time. Accordingly, the convenience for the user improves.

When the delivery items include food items, the information processing apparatus 10 can provide a food item delivery service also to a user on board the traveling vehicle 20. Users who wish to receive a food item while traveling in the vehicle 20 therefore do not need to search on their own for a restaurant capable of providing the desired food item. Users can easily receive the delivery of a desired food item based solely on an input operation within the vehicle 20, even while the vehicle 20 is traveling. Accordingly, the convenience for the user improves.

The information processing apparatus 10 determines a restaurant capable of delivering a first food item ordered for delivery by the user, or a second food item similar to the first food item and included in the same category as the first food item, by the reception time. This enables the information processing apparatus 10 to provide delivery services more flexibly to a user on board the vehicle 20. For example, if there are no candidates for restaurants capable of delivering the first food item ordered by the user, the information processing apparatus 10 can still propose to the user a restaurant capable of delivering a similar second food item in place of the first food item. This allows the user to easily consider a compromise based on the proposal from the information processing apparatus 10 when the user is unable to receive delivery of the desired first food item directly in the traveling vehicle 20. Accordingly, the convenience for the user improves.

The information processing apparatus 10 notifies the restaurant of the order information regarding delivery of a food item when it is judged that the remaining time until the reception time has reached the required time that is required from when the restaurant starts preparing the food item until delivery is complete. This enables the restaurant to deliver the food item immediately to the user on board the vehicle 20 after preparation of the food item is complete, without needing to set the food item aside in the restaurant until delivery. The user can thereby receive a freshly-made food item when the food item is delivered.

The information processing apparatus 10 can provide delivery services more flexibly for users on board the vehicle 20 by optimizing the order information regarding delivery of a food item based on past route information. For example, the information processing apparatus 10 can propose optimized order information to the user if the order information regarding delivery of a food item is not compatible with past route information of the vehicle 20. This enables users to review and optimize, as needed, their order information based on the proposal from the information processing apparatus 10. Accordingly, the convenience for the user improves.

While the present disclosure has been described based on the drawings and examples, it should be noted that various changes and modifications may be made by those skilled in the art based on the present disclosure. Accordingly, such modifications and revisions are included within the scope of the present disclosure. For example, the functions or the like included in each component, step, or the like may be reordered in any logically consistent way. Furthermore, components or steps may be combined into one or divided.

For example, at least some of the processing operations performed in the information processing apparatus 10 in the above embodiment may be performed in the vehicle 20 or the terminal apparatus 30. For example, instead of the information processing apparatus 10, the vehicle 20 itself may perform the processing operations described above with respect to the information processing apparatus 10. At least some of the processing operations performed in the vehicle 20 or the terminal apparatus 30 may be performed in the information processing apparatus 10.

For example, a general purpose electronic device, such as a smartphone or a computer, can also be configured to function as the information processing apparatus 10 according to the above embodiment. Specifically, a program describing the processing content for realizing the functions of the information processing apparatus 10 and the like according to the embodiment is stored in a memory of the electronic device, and the program is read and executed by the processor of the electronic device. Accordingly, the present disclosure can also be embodied as a program executable by a processor.

Alternatively, an embodiment of the present disclosure may be implemented as a non-transitory computer readable medium that stores a program executable by one or more processors to cause the information processing apparatus 10 according to the embodiment or the like to perform the various functions. It is to be understood that these embodiments are also included within the scope of the present disclosure.

For example, the information processing apparatus 10 in the above embodiment may be mounted in the vehicle 20. At this time, the information processing apparatus 10 may communicate information directly with the vehicle 20 without passing through the network 40.

In the above embodiment, the information processing apparatus 10 has been described as acquiring the reception time from the vehicle 20 with respect to the delivery of a food item, but this example is not limiting. The information processing apparatus 10 need not acquire the reception time from the vehicle 20 with respect to the delivery of a food item. In conjunction with this configuration, the information processing apparatus 10 may determine a restaurant capable of delivering a food item to a user on board the vehicle 20 based on the route information and/or the order information, instead of the reception time.

In the above embodiment, the information processing apparatus 10 has been described as determining a restaurant capable of delivering the food item by the reception time while making a comprehensive judgment based on the route information and/or the order information in addition to the reception time, but this example is not limiting. The information processing apparatus 10 may determine a restaurant capable of delivering the food item by the reception time based also on traffic information for the route along which the vehicle 20 is to travel.

In the above embodiment, the information processing apparatus 10 has been described as notifying the restaurant of the order information regarding delivery of a food item when it is judged that the remaining time until the reception time has reached the required time, but this example is not limiting. The information processing apparatus 10 may notify the restaurant of the order information regarding delivery of a food item even when the remaining time until the reception time has not reached the required time.

In the above embodiment, the information processing apparatus 10 has been described as determining the delivery site for delivery of a food item in the same manner as the process to determine the delivery site D3 for the vehicle C3 described with reference to FIG. 6, but this example is not limiting. The information processing apparatus 10 may determine the delivery site in the same manner as the process to determine the delivery site D1 for the vehicle C1 described with reference to FIG. 6. At this time, the information processing apparatus 10 may, for example, take into account the preparation time for the food item in the restaurant and determine the delivery site to be located closer to the location L of the service provider than the delivery site D1 in FIG. 7A. The information processing apparatus 10 may determine the delivery site in the same manner as the process to determine the delivery site D2 for the vehicle C2 described with reference to FIG. 6. At this time, the information processing apparatus 10 may, for example, take into account the preparation time for the food item in the restaurant and determine the delivery site to be located closer to the location L of the service provider than the delivery site D2 in FIG. 7B.

In the above embodiment, the information processing apparatus 10 has been described as acquiring the traffic information for the route along which the vehicle 20 is to travel from the vehicle 20, but this example is not limiting. The information processing apparatus 10 may, for example, acquire traffic information from any appropriate external device connected to the network 40 instead of from the vehicle 20.

In the above embodiment, the information processing apparatus 10 has been described as acquiring the reception time and the order information from the vehicle 20, but this example is not limiting. The information processing apparatus 10 may, for example, acquire these pieces of information from any appropriate external device connected to the network 40 instead of from the vehicle 20.

1. An information processing apparatus comprising a controller configured to:
acquire route information on a route along which a vehicle is to travel; and
determine, based on the acquired route information, a delivery site at which a user on board the vehicle is to receive a delivery item to be delivered to the user.

2. The information processing apparatus of claim 1, wherein the controller is configured to acquire traffic information for the route and determine the delivery site based on the acquired traffic information.

3. The information processing apparatus of claim 1, wherein the controller is configured to acquire a reception time at which the user wishes to receive the delivery item and determine the delivery site based on the acquired reception time.

4. The information processing apparatus of claim 1, wherein the delivery item includes a food item.

5. The information processing apparatus of claim 4, wherein the controller is configured to acquire a reception time at which the user wishes to receive the delivery item and determine a restaurant capable of delivering a first food item ordered for delivery by the user, or a second food item similar to the first food item and included in the same category as the first food item, by the reception time.

6. The information processing apparatus of claim 5, wherein the controller is configured to notify the restaurant of order information regarding delivery of the food item when it is judged that a remaining time until the reception time has reached a required time that is required from when the restaurant starts preparing the food item until delivery is complete.

7. The information processing apparatus of claim 4, wherein the controller is configured to optimize order information regarding delivery of the food item based on past route information.

8. An information processing system comprising:
the information processing apparatus of claim 1;
the vehicle configured to provide the route information to the information processing apparatus; and
a terminal apparatus managed by a service provider that delivers the delivery item to the user on board the vehicle.

9. A non-transitory computer readable medium storing a program executable by one or more processors and configured to cause an information processing apparatus to execute functions comprising:
acquiring route information on a route along which a vehicle is to travel; and
determining, based on the acquired route information, a delivery site at which a user on board the vehicle is to receive a delivery item to be delivered to the user.

10. The non-transitory computer readable medium of claim 9, wherein the functions comprise acquiring traffic information for the route and determining the delivery site based on the acquired traffic information.

11. The non-transitory computer readable medium of claim 9, wherein the functions comprise acquiring a reception time at which the user wishes to receive the delivery item and determining the delivery site based on the acquired reception time.

12. The non-transitory computer readable medium of claim 9, wherein the delivery item includes a food item.

13. The non-transitory computer readable medium of claim 12, wherein the functions comprise acquiring a reception time at which the user wishes to receive the delivery item and determining a restaurant capable of delivering a first food item ordered for delivery by the user, or a second food item similar to the first food item and included in the same category as the first food item, by the reception time.

14. The non-transitory computer readable medium of claim 13, wherein the functions comprise judging whether a remaining time until the reception time has reached a required time that is required from when the restaurant starts preparing the food item until delivery is complete and notifying the restaurant of order information regarding delivery of the food item when it is judged that the remaining time has reached the required time.

15. A vehicle comprising a controller configured to:
acquire route information on a route along which the vehicle is to travel; and
determine, based on the acquired route information, a delivery site at which a user on board the vehicle is to receive a delivery item to be delivered to the user.

16. The vehicle of claim 15, wherein the controller is configured to acquire traffic information for the route and determine the delivery site based on the acquired traffic information.

17. The vehicle of claim 15, wherein the controller is configured to acquire a reception time at which the user wishes to receive the delivery item and determine the delivery site based on the acquired reception time.

18. The vehicle of claim 15, wherein the delivery item includes a food item.

19. The vehicle of claim 18, wherein the controller is configured to acquire a reception time at which the user wishes to receive the delivery item and determine a restaurant capable of delivering a first food item ordered for delivery by the user, or a second food item similar to the first food item and included in the same category as the first food item, by the reception time.

20. The vehicle of claim 19, wherein the controller is configured to notify the restaurant of order information regarding delivery of the food item when it is judged that a remaining time until the reception time has reached a required time that is required from when the restaurant starts preparing the food item until delivery is complete.
